(19) United States
(12) Patent Application Publication
(10) Pub. No.: US 2002/0036272 A1
(43) Pub. Date: Mar. 28, 2002

(54) Charged-particle-beam microlithography methods and apparatus providing reduced reticle heating

(75) Inventor: Teruaki Okino, Kamakura-shi (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 09/942,519

(22) Filed: Aug. 29, 2001

(30) Foreign Application Priority Data
Aug. 29, 2000 (JP) 2000-258588

(51) Int. Cl. G01J 1/00; G01N 21/00; G01N 23/00

(52) U.S. Cl. 250/491.1

(57) ABSTRACT

Charged-particle-beam (CPB) microlithography methods and apparatus are disclosed that suppress increases in reticle temperature caused by CPB irradiation during exposure. The methods and apparatus employ a reticle segmented into subfields or analogous exposure units arranged into minor stripes and at least one major stripe. At least some of the minor stripes comprise a region in which the constituent minor stripes are illuminated multiple times to achieve transfer of the respective pattern portions to a corresponding region on the substrate. Each time a constituent minor stripe is illuminated, the beam energy is reduced, thereby reducing reticle heating. After a subfield in the region has been transferred multiple times to a corresponding transfer subfield on the substrate, the net exposure energy received by the transfer subfield is the same as if the transfer subfield had been exposed only once at a correspondingly higher dose.

### TECHNICAL FIELD

This disclosure pertains to microlithography, which involves the transfer of a pattern, usually defined by a reticle or mask, to the surface of a substrate using an energy beam. For receiving the transferred image, the substrate surface is made “sensitive,” by application of a material termed a “resist,” to exposure by the energy beam. Microlithography is a key technology used in the manufacture of microelectronic devices such as integrated circuits, displays, thin-film magnetic heads, and micro-machines. More specifically, the disclosure pertains to microlithography in which the energy beam is a charged particle beam such as an electron beam or ion beam.

### BACKGROUND

The degree of integration in semiconductor integrated circuits has risen steadily in recent years, accompanied by corresponding increases in the density (number of electronic devices such as transistors per unit area) of circuit patterns. Hence, it can be understood readily that the required accuracy and precision of interlayer alignment and registration are increasing progressively.

Fabrication processes for making modem integrated circuits and related devices have become extremely complex, and typically involve multiple microlithography steps. Most conventional microlithography is performed using “optical” stepper (microlithography) machines. These machines are termed “optical” steppers because the energy beam is within the range of “optical” wavelengths (typically deep ultraviolet) of electromagnetic radiation. The machines are termed “steppers” because of their tendency to perform exposure by a “step-and-repeat” exposure scheme. In step-and-repeat exposure, multiple devices (“dies” or “chips”) are formed on a single wafer, and exposure proceeds from one device to the next, or at least from one exposure unit to the next within a single die, in a step-wise manner.

For optical microlithography, the pattern is defined by a reticle or mask (generally termed a “reticle” herein). The pattern normally is inscribed on the reticle using an electron beam.

The degree of miniaturization of microelectronic devices has progressed to the point that optical microlithography is increasingly unable to resolve the extremely small circuit elements of the devices. In other words, optical microlithography currently is being operated at the diffraction limit of the wavelength of the energy beam, which prevents resolution of increasingly smaller pattern elements using the particular energy beam. Hence, a great effort is ongoing to develop the “next-generation” microlithography technology intended to succeed optical microlithography.

One candidate next-generation microlithography technology is based upon using a charged particle beam, such as an electron beam, as the energy beam. Charged-particle-beam (CPB) microlithography offers prospects of increased pattern resolution for reasons similar to reasons for which electron microscopy achieves much better image resolution than optical microscopy.

Within the realm of CPB microlithography, various approaches have been investigated. One approach involves inscribing the pattern element-by-element by electron-beam writing, similar to the manner in which most reticles conventionally are produced. However, a serious drawback of this approach for large-scale fabrication of microelectronic devices is that its “throughput” (number of wafers that can be processed per unit time) is extremely low. Other approaches achieve better throughput, but the currently practical approaches all have respective throughputs that are lower than currently achievable using optical microlithography.

For example, in the approach variously termed “cell projection,” “character projection,” or “block exposure,” a highly repeated (but very small, about 5μm- square on the substrate) fundamental graphic unit of the pattern is exposed repeatedly to form a part of the overall pattern made up of the highly repeated portions. The fundamental unit is defined, typically many times, on a reticle. During exposure, one of the units on the reticle is selected for exposure at a given instant; as exposure progresses, different units on the reticle are selected so as to avoid over-heating or over-using any single unit. By way of example, this approach typically is used for fabricating memory chips and the like, wherein the highly repeated graphic unit is a memory cell or portion thereof. One disadvantage of this approach is that portions of the overall pattern not comprised of highly repeated graphic units must be exposed using another technique such as use of a variable-shaped beam, which reduces overall throughput.

A CPB microlithography approach that offers tantalizing prospects of vastly increased throughput involves exposing an entire die pattern simultaneously, similar to what is done in optical microlithography. According to this approach, the entire die pattern is defined on a reticle and is projection-exposed, usually with demagnification, onto the surface of the substrate using an electron beam. Unfortunately, it has been impossible to date to expose an entire pattern in one “shot” using an electron beam. First, making a reticle suitable for one-shot whole-reticle exposure is impossible using current technology. Second, the electron optics must be extremely large to expose a field sufficiently large to encompass an entire reticle; such optical systems are prohibitively expensive to manufacture and operate. Third, with optical systems having large fields, it currently is impossible to control aberrations, especially off-axis aberrations, adequately for yielding acceptable lithography results.

Another CPB microlithography approach offers the best current prospects for commercial practicality. This approach, termed “divided-reticle” projection microlithography, has received considerable recent attention. It involves dividing a die pattern, as defined on the reticle, into multiple respective subunits (usually termed “subfields”) that are exposed individually. Thus, the optical system need not have as large a field as in one-shot whole-reticle exposure. As each subfield is exposed, certain aberration corrections can be made in real time, including corrections of image focal point. The respective images of the subfields are positioned on the substrate such that they are “stitched” together properly to create the entire pattern on the substrate in each die. Divided-reticle exposure can be performed with excellent resolution and precision over a much larger optical field than achievable using fill-pattern single-shot exposure.

Whenever a reticle is irradiated with a charged particle beam, heat is generated by interaction of the irradiating charged particles of the beam with the material of the reticle. This heat can accumulate in the reticle and cause thermal deformation and distortion of the reticle. Various techniques have been devised for reducing absorption of a charged particle beam by the reticle. One technique is to configure the pattern-defining portions of the reticle as or on very thin membranes. Unfortunately, such reticles are extremely delicate. Also, even with this technique, some temperature increase still occurs in irradiated subfields of the reticle, which results in unwanted thermal distortion. Although this distortion may at first consideration seem trivial, it can result in positional deviations of, for example, about 5 nm on the wafer, which is unacceptable for achieving modern levels of integration. For example, this level of positional deviation can result in significant misalignment of the pattern on the substrate, decrease in overlay precision between layers, and sub-optimal stitching together of subfield images on the substrate. These problems are manifest as reduced performance of the microelectronic devices that actually are produced.

### SUMMARY

In view of the shortcomings of conventional technology as summarized above, an object of the instant claims is to provide charged-particle-beam (CPB) microlithography methods and apparatus that suppress increases in reticle temperature caused by the CPB irradiation during exposure. Accompanying such suppression of reticle-temperature increases are reduced pattern misalignments on the substrate and enhanced exposure overlay precision and stitching accuracy.

In one embodiment of a charged-particle-beam (CPB) microlithography method according to the invention, a pattern is defined on a segmented reticle that is divided into multiple exposure units each defining a respective portion of the pattern that is transferred by a charged particle beam to a respective location in a die on a sensitive substrate. The exposure units are arranged on the reticle in a grid array extending in X and Y directions. The grid array includes minor stripes each extending in the X direction and being arranged in the Y direction. Each minor stripe comprises at least one exposure unit. A charged-particle illumination beam is deflected successively in the X direction to illuminate each exposure unit in each minor stripe and to illuminate the minor stripes in an ordered manner. In a region on the reticle including one or more minor stripes, the one or more minor stripes are illuminated multiple times such that the respective exposure units are illuminated multiple times by the illumination beam and transferred to the respective locations in the die on the substrate.

Thus, the required exposure dose for a given location on the substrate is obtained by multiple exposures at the location. During each exposure at a location, the beam-current intensity of the illumination beam can be lower than the current density otherwise would be if the location were exposed only once. Due to the lower current density at any location on the reticle, reticle-temperature increases (and corresponding thermal expansion of the reticle) are suppressed. This, in turn, reduces pattern misalignment on the substrate caused by the thermal expansion of the reticle, with correspondingly enhanced overlay accuracy and stitching accuracy of exposure units. By way of example, each minor stripe in the region (and hence each subfield in the minor stripe) is illuminated each of n times by the illumination beam at an illumination-dose that is 1/n times the illumination-dose that otherwise would be received by the minor stripe if the minor stripe were illuminated only once.

The exposure units can be respective subfields, wherein each minor stripe comprises multiple respective subfields. The reticle typically includes multiple regions that are transferred individually to the die, and each region typically includes multiple respective minor stripes. Desirably, the minor stripes in each region are illuminated multiple times to complete transfer of the region to the die before illumination progresses to the next region. Also, desirably, the regions are transferred sequentially to the die.

In another embodiment, the exposure units are respective subfields, and the reticle includes multiple major stripes that are transferred individually to the die.

Each major stripe comprises multiple regions each comprising multiple respective minor stripes, wherein the regions are transferred individually to the die. Each minor stripe comprises multiple respective subfields. The minor stripes in each region are illuminated multiple times to complete transfer of the region to the die before illumination progresses to the next region. During exposure of each region, the respective constituent minor stripes desirably are illuminated according to a predetermined order before repeating exposure of the minor stripes of the region.

In yet another embodiment, the exposure units are respective subfields, and the reticle comprises multiple minor stripes grouped into multiple regions that are transferred individually to the die. Each region comprises multiple respective minor stripes each comprising multiple respective subfields. The minor stripes in each region are illuminated multiple times to complete transfer of the region to the die before illumination progresses to the next region. During exposure of each region, all the constituent minor stripes desirably are illuminated according to a predetermined order before repeating exposure of the minor stripes of the region.

In yet another embodiment, each region comprises multiple respective minor stripes, and each minor stripe comprises multiple respective exposure units. During exposure of each region the illumination beam is deflected in the X direction to illuminate each respective exposure unit in a minor stripe and in the Y direction to progress from one minor stripe to another in the region. During exposure of the pattern, progression from one region on the reticle to the next can be achieved by moving the reticle in the Y direction.

Another method embodiment is directed to performing CPB microlithography of a pattern to a die on a sensitive substrate. The pattern as defined on the reticle is divided into multiple major stripes of respective subfields arrayed in an X-Y grid on the reticle. Each major stripe comprises multiple respective minor stripes each extending across a width of the respective major stripe. At least one major stripe comprises a respective group of constituent minor stripes that are exposed more than once in the die. Using a charged-particle illumination beam and a corresponding charged-particle patterned beam, the major stripes, the minor stripes within each major stripe, and the subfields within each minor stripe are transferred in an ordered manner. Each of the minor stripes in the group are transferred in an ordered manner multiple times to respective minor stripes on the die.

By way of example, each minor stripe in the group is transferred each of n times at an exposure dose that is 1/n times the exposure dose that otherwise would be received by the minor stripe if the minor stripe were illuminated only once.

Typically, each major stripe includes multiple respective groups that are transferred individually to the die. Also, each group typically comprises multiple respective minor stripes. The minor stripes in each group are transferred multiple times to complete transfer of the group to the die before illumination progresses to the next group. During exposure of each group, the respective constituent minor stripes can be transferred according to a predetermined order before repeating exposure of the minor stripes of the group.

During transfer of each constituent subfield of a minor stripe, the subfield typically is illuminated by an illumination beam that is deflected in the X direction to illuminate in a sequential manner all the subfields of the minor stripe. In such a configuration, progression from one group on the reticle to the next can be achieved by moving the reticle in the Y direction.

Any of various embodiments of a CPB microlithography apparatus are possible. The apparatus is configured for transferring a pattern, defined on a segmented reticle divided into multiple exposure units each defining a respective portion of the pattern, to a substrate. The exposure units are grouped into at least one major stripe comprising multiple minor stripes of respective exposure units. The minor stripes extend in an X direction and are arrayed in the major stripe in the Y direction. The apparatus comprises, along a Z direction, an illumination-optical system, a reticle stage, a projection-optical system, a wafer stage, and a main controller. The illumination-optical system is configured to direct an illumination beam from a source to the reticle. The reticle stage is situated downstream of the illumination-optical system and is configured to hold the reticle. The projection-optical system is situated downstream of the reticle stage and is configured to direct a patterned beam from the reticle to the substrate. The wafer stage is situated downstream of the projection-optical system and is configured to hold the substrate during exposure of the substrate. The main controller connected to the illumination-optical system, the reticle stage, the projection-optical system, and the wafer stage. The main controller is configured to: (1) control transfer of the pattern from the reticle to a substrate mounted to the wafer stage, (2) successively deflect the illumination beam in an X direction to illuminate each exposure unit in each minor stripe and to illuminate the minor stripes in an ordered manner, and (3) in a region on the reticle including one or more minor stripes, illuminate the minor stripes multiple times such that the respective exposure units are transferred multiple times to respective locations in the die on the substrate.

Another embodiment of a CPB microlithography apparatus is used for transferring a pattern, defined on a segmented reticle divided into multiple subfields each defining a respective portion of the pattern, to a substrate. The subfields are grouped into multiple major stripes each comprising multiple respective minor stripes each comprising multiple respective subfields. At least one major stripe comprises a respective group of constituent minor stripes that are exposed more than once in the die. The apparatus comprises, along a Z direction, an illumination-optical system, reticle stage, projection-optical system, and wafer stage as summarized above. The apparatus also comprises a main controller connected to the illumination-optical system, the reticle stage, the projection-optical system, and the wafer stage. The main controller is configured to control transfer of the pattern from the reticle to a substrate mounted to the wafer stage, during which transfer the major stripes, the minor stripes within each major stripe, and the subfields within each minor stripe are transferred in an ordered manner using the illumination beam and the patterned beam. The main controller also is configured to control transfer of each of the minor stripes in the group in an ordered manner multiple times to respective minor stripes in the die.

The foregoing and additional features and advantages of the invention will be more readily apparent from the following detailed description, which proceeds with reference to the accompanying drawings.

### BRIEF DESCRIPTION OF THE DRAWINGS

FIG. 1 is an elevational schematic diagram showing basic optical and control elements of a charged-particle-beam (CPB) microlithography apparatus with which a divided reticle can be exposed according to any of the various exposure schemes as described herein.

FIGS. 2(A)-2(C) depict various aspects of a divided reticle as used herein for exposing a substrate, wherein FIG. 2(A) is a plan view of the reticle, FIG. 2(B) is an oblique view of a portion of the reticle, and FIG. 2(C) is a plan view of a single subfield of the reticle.

FIG. 3 is an oblique schematic view showing certain aspects of transferring a pattern, defined by a divided reticle, to a substrate.

FIGS. 4(A)-4(B) are plan views showing respective beam-scanning paths on minor stripes of a reticle (left-hand portion of each figure) and of a substrate (right-hand portion of each figure). FIG. 4(A) illustrates the beam-scanning paths of a representative exposure-method embodiment as described herein, and FIG. 4(B) illustrates the beam-scanning paths as used in a conventional exposure method.

FIG. 5 is a flow chart showing certain steps of a process used for fabricating a microelectronic device such as an integrated circuit, display panel, CCD, thin-film magnetic head, or a micromachine.

### DETAILED DESCRIPTION

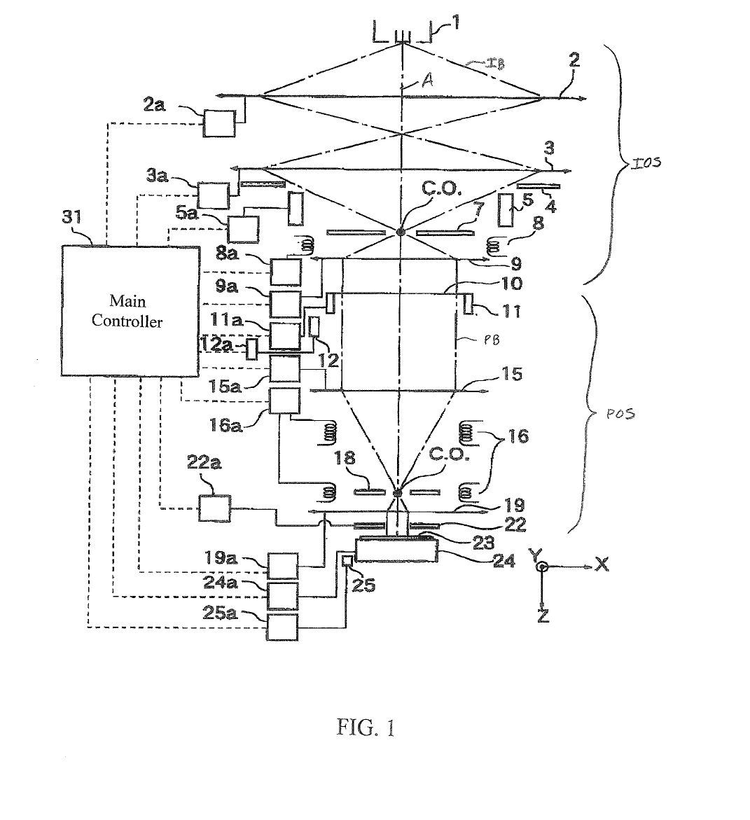

First to be described is a representative embodiment of a charged-particle-beam (CPB) microlithography system (employing an electron beam as an exemplary charged particle beam) for performing projection exposure of a divided reticle. The embodiment is illustrated in FIG. 1 showing salient aspects of the CPB-optical system and control system.

An electron gun 1 is disposed at the extreme upstream end of the system. The electron gun 1 emits an electron beam that propagates in a downstream direction along an optical axis A toward a reticle 10. The electron beam propagating between the electron gun 1 to the reticle 10 is termed the “illumination beam”IB, and the portion of the CPB-optical system situated between the electron gun 1 and the reticle 10 is termed the “illumination-optical system” IOS.

The illumination-optical system IOS comprises a two-stage condenser-lens assembly comprising a first condensing lens 2 and a second condensing lens 3. The illumination beam IB passes through the condensing lenses 2, 3 and forms a crossover (C.O.) image at a blanking aperture 7.

The illumination-optical system IOS also comprises a beam-shaping aperture 4 downstream of the second condensing lens 3. The beam-shaping aperture 4 trims outlying portions of the illumination beam IB and thus only transmits a portion of the illumination beam sufficient for illuminating a single subfield or other exposure unit on the reticle 10. On a reticle 10 comprised of multiple subfields, each subfield defines a respective portion of the overall pattern and thus serves as a respective exemplary exposure unit. By way of example, the beam-shaping aperture 4 defines an opening that is square shaped, having dimensions suitable for illuminating a subfield ranging from 0.5 to 5 mm square on the reticle. An image of the opening in the beam-shaping aperture 4 is formed on the reticle by passing the illumination beam IB through an illumination lens 9.

The illumination-optical system IOS also includes a blanking deflector 5 situated downstream of the beam-shaping aperture 4. The blanking deflector 5 is configured to deflect the illumination beam IB as required to direct the beam, during “blanking,” at a portion of the blanking aperture 7 that will block the beam. Thus, during blanking, the illumination beam IB is prevented from reaching the reticle 10.

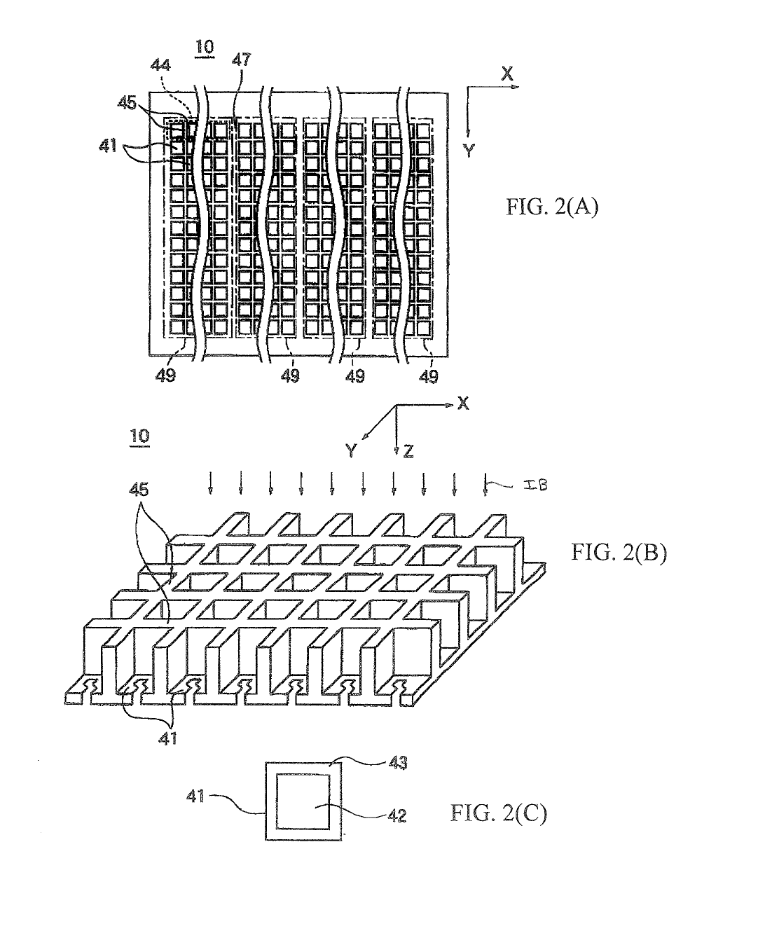

The illumination-optical system IOS also includes a subfield-selection deflector 8 situated downstream of the blanking aperture 7. The subfield-selection deflector 8 primarily serves to scan (sweep) the illumination beam IB to the left and right in FIG. 2 (i.e., the X direction) to illuminate, in a successive manner, a series of subfields of the reticle 10 that are located within the optical field of the illumination-optical system IOS. The illumination lens 9 is situated downstream of the subfield-selection deflector 8.

Even though only one exposure unit of the reticle 10 is shown in FIG. 1 (on the optical axis A), it will be understood that the reticle 10 actually extends outward within the plane (X-Y plane) perpendicular to the optical axis and has a large number of exposure units such as subfields (described below with reference to FIGS. 2(A)-2(C)). The reticle 10 typically defines an entire die pattern (chip pattern) for forming a particular layer of a microelectronic device formed on a substrate.

The reticle 10 is mounted on a reticle stage 11 that is movable in the X-Y plane to place the various exposure units on the reticle into position for illumination by the illumination beam IB. The reticle stage 11 includes a position detector 12 comprising at least one laser interferometer for accurately determining, in real time, the position of the reticle stage 11 in the X-Y plane.

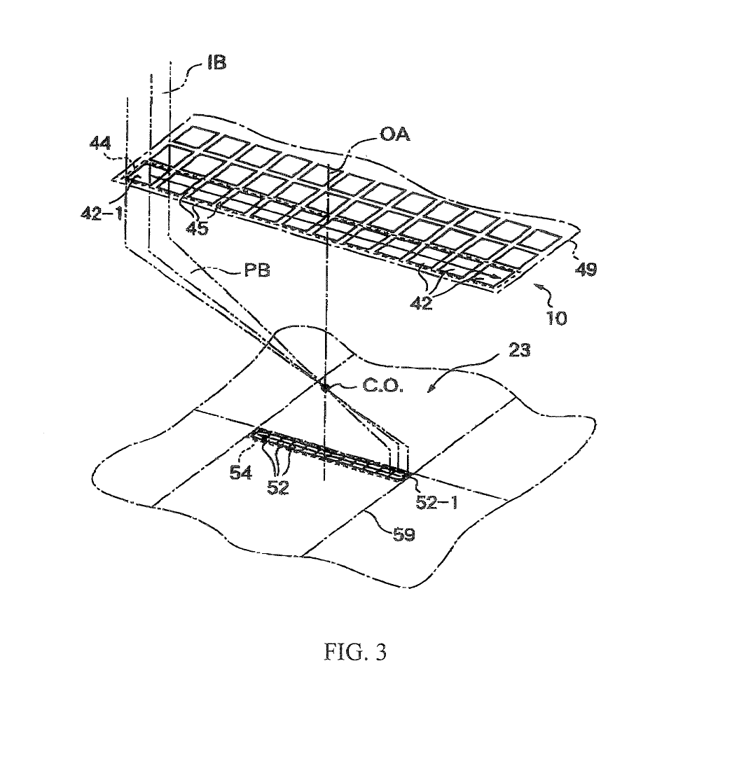

Between the reticle 10 and a substrate 23 is a “projection-optical system” POS comprising first and second projection lenses 15, 19, respectively, and an imaging-position deflector 16. As the illumination beam IB irradiates a selected exposure unit, portions of the illumination beam are transmitted through the reticle 10 and thus become a “patterned” beam or “imaging” beam PB. The projection-optical system POS is configured to manipulate the patterned beam PB so as to form an image of the irradiated exposure unit on a corresponding location on the substrate 23. The actions of the projection lenses 15, 19 and the imaging-position deflector 16 are described below with reference to FIG. 3. So as to be imprintable with the respective images of the exposure units, the upstream-facing surface of the substrate 23 (typically a semiconductor wafer) is coated with a suitable resist. Upon exposure of the resist by the patterned beam PB, an image of the respective pattern portion carried by the patterned beam is imprinted in the resist.

A crossover image C.O. is formed at an axial location at which the axial distance between the reticle 10 and substrate 23 is divided by the demagnification ratio of the projection lenses 15, 19. A contrast aperture 18 is situated at the crossover C.O. The contrast aperture 18 blocks outlying portions of the patterned beam PB comprised of charged particles that were scattered by non-patterned portions of the reticle 10, thereby preventing these scattered particles from reaching the substrate 23.

The substrate 23 is mounted on a wafer chuck (e.g., electrostatic chuck, not shown) on a wafer stage 24. The wafer stage 24 is movable in the X-Y plane so as to ensure that each projected exposure unit is imaged at the correct respective location on the substrate 23. Typically, the various exposure units are exposed successively by synchronously moving the reticle stage 11 and wafer stage 24 in a scanning manner in mutually opposite directions. The position of the wafer stage 24 in the X-Y plane is detected using a position detector 25, which is similar in structure and function to the position detector 12 for the reticle stage 11.

A backscattered-electron (BSE) detector 22 is disposed directly upstream of the substrate 23. The BSE detector 22 detects and quantifies electrons backscattered from, for example, a mark on an unexposed location on the substrate 23, on an exposed location on the substrate, or on the wafer stage 24. For instance, the relative positional relationship between the reticle 10 and the substrate 23 can be ascertained by scanning a mark on the substrate 23 with a beam that has passed through a corresponding mark pattern on the reticle 10, and detecting electrons backscattered from the mark on the substrate 23.

The various lenses 2, 3, 9, 15, 19 and deflectors 5, 8, 16 are connected to respective coil-power-supply controllers 2a, 3a, 9a, 15a, 19a and 5a, 8a, 16a, respectively. Each of these controllers is connected to and controlled by a main controller 31. Respective movements and positions of the reticle stage 11 and wafer stage 24 are controlled by the main controller 31 via respective stage controllers 11a, 24a. The stage-position detectors 12, 25 produce and route stage-position data to the main controller 31 via respective interfaces 12a, 25a. To such end, each interface 12a, 25a comprises amplifiers and analog-to-digital (A/D) converters. The main controller 31 also receives data from the BSE detector 22 via an interface 22a.

Based on data input to the main controller 31 as described above, the main controller 31 determines control errors in stage positions and corrects such errors using, for example, the imaging-position deflector 16. As a result of this control, demagnified (reduced) images of the reticle subfields or other exposure units are transferred accurately to respective target positions (“transfer subfields”) on the substrate 23. The various images are positioned so as to be “stitched” together properly on the substrate 23 in the image of the entire die pattern as formed on the substrate 23.

Details of a segmented reticle 10 are depicted in FIGS. 2(A)-2(C), wherein FIG. 2(A) provides a plan view of the reticle, FIG. 2(B) provides an oblique view of a portion of the reticle, and FIG. 2(C) provides a plan view of a subfield. A reticle as shown in these figures can be fabricated by “drawing” a pattern on a reticle blank using electron-beam writing, followed by etching.

Turning first to FIG. 2(A), it can be seen that the depicted reticle 10 is divided into multiple subfields 41 (as representative exposure units). The subfields 41 are separated from one another by minor struts 45 and arranged in rows and columns across the reticle. As shown, the rows 44 extend in the X direction, and the columns extend in the Y direction. Respective groups of rows and columns of subfields 41 constitute “major stripes” 49 each extending in the Y direction and divided from each other by major struts 47. Note that, in the depicted reticle, multiple major stripes 49 are arrayed in the X direction.

The rows 44 also are termed “minor stripes.” The length of the minor stripes 44 (in the X direction), wherein this length also is the width of the respective major stripe 49, corresponds to the width of the deflectable field of the illumination-optical system IOS.

The respective pattern portion in each subfield 41 is defined on a respective membrane region 42 with a surrounding non-patterned skirt 43 (FIG. 2(C)). Depending upon the particular type of reticle, the membrane region 42 has a thickness ranging from 0.1 μm to several micrometers. Hence, each membrane region 42 is an area where the respective pattern portion of the subfield is defined. No pattern is present in the skirts 43. For each subfield, the respective skirt 43 is a peripheral zone where the edges of the illumination beam IB are incident whenever the beam is illuminating the subfield.

The reticle 10 can be a scattering-stencil type, in which pattern elements are defined by through-holes in a relatively scattering membrane, or a scattering-membrane type in which pattern elements are defined by respective “scattering bodies” formed from a layer of beam-scattering material applied on a relatively non-scattering membrane.

By way of example, each subfield 41 has a size on the reticle of about 0.5 to 5 mm square. (The width of each skirt 43 is about 0.05 mm, for example.) With a demagnification ratio of 1/5, each such subfield produces on the substrate a respective “transfer subfield” having a size of 0.1 to 1 mm square.

The minor struts 45 project in the Z direction from corresponding regions flanking the skirts 43 of the subfields 41, and thus collectively constitute a “grillage” on the reticle. By way of example, each minor strut 45 has a thickness (in the Z direction) of about 0.5 to 1 mm, and a width (in the X or Y direction) of about 0.1 mm. Each major strut 47, which is an integral part of the grillage, has a thickness (in the Z direction) that is the same as the thickness of a minor strut 45, and a width (in the X direction) of several millimeters. Thus, the struts 45, 47 are configured and dimensioned for effectively providing the reticle with substantial mechanical strength.

In general, exposure of a reticle 10 occurs stripe-by-stripe, row-by-row within each major stripe 49, and exposure-unit-by-exposure-unit (e.g., subfield-by-subfield) within each row 44. For example, in a row 44 containing multiple subfields separated from each other by respective minor struts, the illumination beam is deflected in the X direction so as to illuminate the subfields in a sequential manner. This deflection is performed using the subfield-selection deflector 8. Within each major stripe 49, successive rows 44 are placed into position for exposure by continuous scanning motion of the reticle stage 10 in the Y direction. To expose the next major stripe 49, the reticle stage 10 is moved intermittently as required.

In an alternative configuration of the reticle 10, the exposure units in each row 44 do not have minor struts 45 therebetween. In such a configuration, the entire row 44 is a respective exposure unit that can be exposed by scanning the illumination beam in a continuous manner in the X direction.

During exposure of each subfield, non-patterned regions of the reticle 10 (e.g., skirts 43 and grillage) are not exposed. The images of the subfields, as formed on the substrate 23, are placed contiguously with each other (i.e., are “stitched” together) to form the entire reticle pattern.

FIG. 3 depicts certain aspects of the exposure scheme described above for transferring a pattern from the reticle 10 to the substrate 23. Part of a major stripe 49 on the reticle 10 is shown in the upper part of the figure. The portion includes multiple subfields 42 (skirts are not shown) and minor struts 45 in the major stripe 49. A substrate 23 facing the reticle 10 is shown in the lower part of the figure.

In the figure, a subfield 42-1 in the left corner of the first minor stripe 44 on the reticle 10 is being illuminated from upstream by the illumination beam IB. The patterned beam PB, produced by passage of the illumination beam IB through the subfield 42-1, is reduced (demagnified) and projected onto a corresponding region (“transfer subfield”) 52-1 on the substrate 23 by the projection-optical system (not shown, but see FIG. 1).

During propagation from the reticle 10 to the substrate 23, the patterned beam PB is deflected twice by the projection-optical system POS. The first deflection is from a direction parallel to the optical axis to a direction in which the beam intersects the optical axis OA. The second deflection is opposite the first deflection to ensure that the patterned beam PB has zero angle of incidence on the substrate 23.

The respective positions on the substrate 23 at which the subfield images are formed are adjusted as required by the imaging-position deflector 16 (FIG. 1) in the projection-optical system. The imaging-position deflector 16 actually comprises a first deflector for performing beam deflection in the X direction and a second deflector for performing beam deflection in the Y direction. Such deflection ensures proper stitching of the subfield images adjacent to and contiguously with each other. If the patterned beam PB were merely converged on the substrate 23 by the projection lenses 15, 19 without appropriate deflection by the imaging-position deflector 16, then the images formed on the substrate would be not only of subfields 41 but also of the grillage 45 and skirts 43. In other words, the transfer subfields 52 as formed on the substrate 23 would be separated from each other by images of grillage and skirts. To eliminate all but respective pattern portions in the subfield images as transferred to the substrate, the respective positions of the transfer subfields must be shifted to eliminate grillage and skirts, and to place the images of respective pattern portions contiguously with each other. The amount of shift required corresponds to the width of the non-patterned regions (grillage and skirts) that are eliminated in the transferred images.

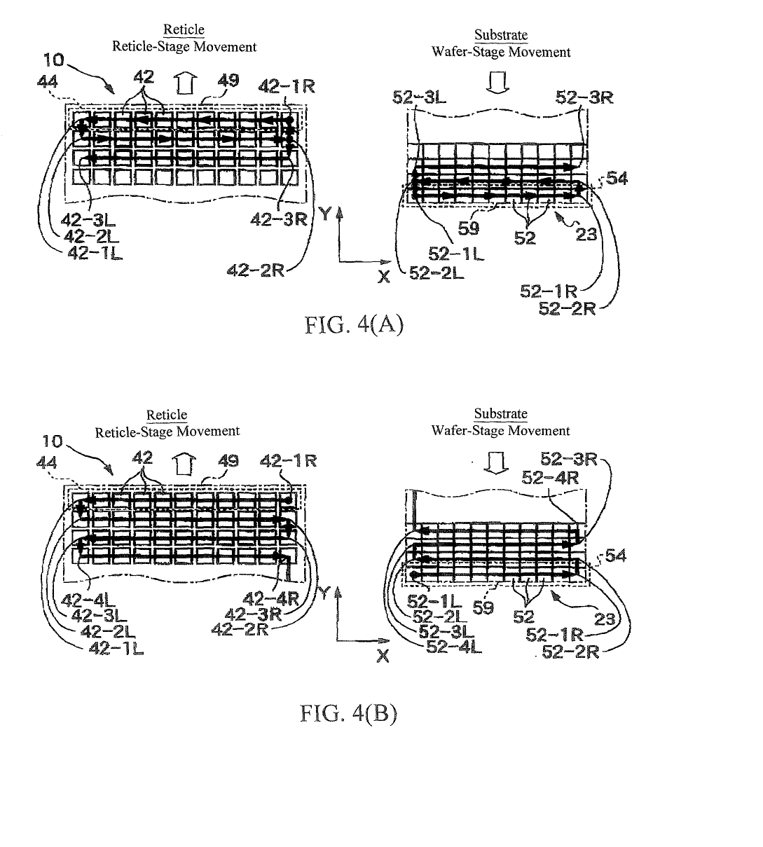

A representative method for scanning exposure of a pattern from a reticle to a substrate is described with reference to FIGS. 4(A) and 4(B) each schematically depicting respective exposure-scanning paths over the reticle and substrate.

FIG. 4(A) illustrates a scanning path within a region of the reticle containing two constituent minor stripes 44. Within the depicted region (consisting of the first two minor stripes) the minor stripes 44 (and hence the respective subfields within each minor stripe of the region) are exposed multiple times before proceeding to the next region. For comparison, FIG. 4(B) illustrates a conventional scanning path in which each minor stripe (and hence the respective subfields within each minor stripe) are exposed only once in each die. Bold arrows in the figures denote respective exposure-scanning paths.

The respective left-hand portion of each of FIGS. 4(A) and 4(B) depicts a portion of a major stripe 49 on the reticle 10. As shown in FIGS. 2(A)-2(C) and 3, each major stripe 49 includes multiple minor stripes (rows) 44 and a large number of subfields 42 (as representative exposure units). The respective right-hand portion of each of FIGS. 4(A)-4(B) depicts a portion of a major-stripe image 59 as transferred to the substrate 23. Each major-stripe image 59 contains multiple transfer subfields 52.

Beginning with a conventional exposure scheme (FIG. 4(B)), and considering first the reticle 10 (left-hand portion of the figure), the uppermost (in the figure) or first minor stripe 44 in the major stripe 49 is scanned from the right-hand subfield 42-1R to the left-hand subfield 42-1L. Then, the illumination beam moves to the subfield 42-2L directly “beneath” the subfield 42-1L. From the subfield 42-2L, the illumination beam scans the second minor stripe 44 rightward to the subfield 42-2R. Further scanning proceeds in a similar manner for the depicted subfields 42-3R and 42-3L, and 42-4L and 42-4R in the third and fourth minor stripes, respectively, and in subsequent minor stripes 44 of the major stripe 49.

Meanwhile, on the substrate 23 (right-hand portion of the figure), the lowermost (in the figure), or first, minor stripe 54 in the major stripe 59 is scanned from the left-hand transfer subfield 52-1L to the right-hand transfer subfield 52-1R. Then, the patterned beam moves to the transfer subfield 52-2R directly “above” the transfer subfield 52-1R. From the transfer subfield 52-2R, the patterned beam scans the second minor stripe 54 leftward to the transfer subfield 52-2L. Further scanning proceeds in a similar manner for the depicted transfer subfields 52-3L and 52-3R, and 52-4R and 52-4L in the third and fourth minor stripes, respectively, and in subsequent minor stripes 54 of the major stripe 59.

In the lengthwise direction (-X direction) of the minor stripes 44 and 54, the respective beam is scanned primarily by deflection. In the lateral direction (Y direction) of the minor stripes 44 and 54, scanning is accomplished by mechanically moving the reticle 10 and substrate 23 via their respective stages.

A charged particle beam used as either an illumination beam or a patterned beam contains substantial energy. As scanning progresses along a minor stripe 44 of a reticle 10, the temperature of the subfield currently being irradiated progressively increases such that the last subfield in the minor stripe to be exposed is hotter (at the instant of exposure) than the first subfield in the minor stripe. This temperature difference results in distortion of the reticle. For example, consider a situation in which the acceleration voltage of the illumination beam is 100 kV, the thickness of the reticle membrane is 2 μm, and the illumination current is 25 μA. If a minor stripe of subfields (each being 1-mm square on the reticle) in the deflection direction (X direction) is exposed onto a substrate having a resist sensitivity of 5 μC./cm², then the temperature of the last subfield in the minor stripe is about 2° C. hotter at the instant of exposure than the first subfield. This results in a reticle distortion of about 20 nm. At a demagnification ratio of 1/4, this reticle distortion causes a misalignment of about 5 nm of the pattern as projected onto the substrate. This misalignment, in turn, reduces overlay accuracy between layers of the die and reduces the stitching accuracy of adjacent subfields as projected onto the substrate. As a result, the performance of the microelectronic device is compromised.

A scanning-exposure method according to an embodiment of the invention is shown in FIG. 4(A). Considering first the reticle 10 (right-hand portion of the figure), the uppermost (in the figure) or first minor stripe 44 in the major stripe 49 is scanned from the right-hand subfield 42-1R to the left-hand subfield 42-1L. Then, the illumination beam moves to the subfield 42-2L directly “beneath” the subfield 42-1L. From the subfield 42-2L, the illumination beam scans the second minor stripe 44 rightward to the subfield 42-2R. The first and second minor stripes 44 in this example constitute a first “region” in which the constituent minor stripes are exposed multiple times before proceeding to a second region. Hence, after scanning the second minor stripe 44, the illumination beam returns to the initial subfield 42-1R in the first minor stripe, and scanning is repeated over the subfields of the first and second minor stripes 44 in the order 42-1R to 42-1L, 42-1L to 42-2L, and 42-2L to 42-2R. The illumination beam then returns to the initial subfield 42-1R, and similar sequential scanning of the first two minor stripes is repeated two more times. After sequentially scanning the first two minor stripes a total of four times as described above, the illumination beam then proceeds to the subfield 42-3R situated “below” the subfield 42-2R in the third minor stripe 44. The illumination beam then scans the third minor stripe from the subfield 42-3R to the subfield 42-3L, and proceeds to scan the fourth minor stripe from the subfield 42-4L to the subfield 42-4R. The third and fourth minor stripes 44 constitute a second “region” in which the constituent minor stripes are exposed multiple times before proceeding to a subsequent region. Hence, after scanning the fourth minor stripe, the illumination beam scans the third and fourth minor stripes 44 three more times (for a total of four times) in a manner similar to the scanning of the first and second minor stripes. Scanning then proceeds to the fifth minor stripe (not shown but situated in the third “region”), and so on in a similar manner.

Meanwhile, on the substrate 23 (right-hand portion of the figure), the lowermost (in the figure) or first minor stripe 54 in the major stripe 59 is scanned from the left-hand transfer subfield 52-1L to the right-hand transfer subfield 52-1R. Then, the patterned beam moves to the transfer subfield 52-2R directly “above” the transfer subfield 52-1R. From the transfer subfield 52-2R, the patterned beam scans the second minor stripe 54 leftward to the transfer subfield 52-2L. The patterned beam then returns to the initial transfer subfield 52-1R in the first minor stripe 54, and scanning is repeated over the transfer subfields of the first and second minor stripes 54 in the order 52-1R to 52-1L, 52-1L to 52-2L, and 52-2L to 52-2R. The patterned beam then returns to the initial transfer subfield 52-1R, and similar sequential scanning of the first and second minor stripes 54 is repeated two more times. After sequentially scanning the first and second minor stripes 54 a total of four times as described above, the patterned beam then proceeds to the transfer subfield 52-3R situated in the third minor stripe 54 “above” the transfer subfield 52-2R. The patterned beam then scans the third minor stripe 54 from the transfer subfield 52-3R to the transfer subfield 52-3L, and proceeds to scan the fourth minor stripe 54 from the transfer subfield 52-4L to the transfer subfield 52-4R. Afterward, the patterned beam scans the third and fourth minor stripes 54 three more times (for a total of four times) in a manner similar to the scanning of the first and second minor stripes. Scanning then proceeds to the fifth minor stripe (not shown), and so on in a similar manner.

In the scheme shown in FIG. 4(A), scanning of the illumination beam and patterned beam in the Y direction is performed as the reticle 10 and wafer 23 undergo scanning movements at respective constant velocities. The beams are deflected in the Y direction over the respective paths that trace the respective portions of the pattern multiple times. The deflection field of the illumination- and projection-optical systems is a high-precision field sufficiently large to accommodate the necessary beam deflections in the Y direction without generating excessive aberrations.

Even with the scheme shown in FIG. 4(A), impingement of the illumination beam on the reticle raises the local temperature of the irradiated subfields, which causes reticle distortion. However, this scheme allows the energy of the illumination beam to be reduced to one-fourth the energy required in the conventional scheme. Consequently, with the scheme according to this embodiment, there is less local increase in subfield temperature, with a correspondingly reduced reticle distortion, while still providing a net exposure dose for each subfield equal to the dose obtained using the conventional scheme.

For example, consider an electron illumination beam, accelerated by 100 kV, incident on a subfield sized at 1 -mm square on a reticle membrane 2 μm thick, and a resist sensitivity of 5 μC./cm². If the illumination current is (25 μA)/4=6.25 μA rather than 25 μA, then the increase in local temperature of the last subfield in a minor stripe is no more than about 0.5° C., which is one-fourth the temperature increase realized with the conventional scheme. Also, reticle distortion is about 5 nm or less, which is one-fourth the reticle distortion observed with the conventional scheme. This improvement allows pattern misalignments on the wafer to be maintained at approximately 1 nm, which is one-fourth the pattern misalignment observed with the conventional scheme. This degree of misalignment poses no problem with either layer-overlay accuracy or stitching accuracy.

With this embodiment, since each transfer subfield on the substrate is exposed multiple times, more statistically significant subfield-deflection movements are made. Hence, it would be expected that exposure of a substrate would require substantially more time than conventionally. Specifically, with this embodiment in which regions each containing two respective rows of minor stripes are exposed by sweeping each constituent minor stripe four times, the statistically significant minor-stripe-exposure time is four times longer than with the conventional scheme, which would be expected to yield 1/4 the throughput of the conventional scheme. However, this statistically significant minor-stripe-exposure time does not account for a large proportion of the overall substrate-exposure time. As a result, the overall increase in exposure time per wafer is only about ten percent. An increase of this magnitude is well within the acceptable range for practical purposes. Hence, this embodiment is suited for performing exposures of fine patterns wherein exposure accuracy is especially important.

In the scanning-exposure scheme described above, the unit region for each group of multiple exposures is two minor stripes, wherein the subfields or other exposure units within each such region are exposed by being swept multiple times with a charged particle beam. In another representative embodiment, the region is enlarged to include all the subfields in a major stripe (see FIG. 2(A)). In this alternative embodiment, all the minor stripes of a major stripe are swept multiple times before exposure progresses to the next major stripe.

For example, if all of the subfields in a major stripe are swept four times to achieve exposure of the major stripe, then the temperature increase in the subfields and the extent of the accompanying misalignment of the pattern on the substrate are no greater than conventionally. As a result, no problems occur with either overlay accuracy between layers or stitching accuracy of subfields within a single layer. Respective mechanical movements of the reticle and substrate in the Y direction are conducted a total of four times (twice in each of the +Y and −Y directions).

With this alternative embodiment, however, not only is there an increase in the number of statistically significant subfield-deflection movements, but also there is an increase in the number of overhead stage movements in the Y direction. This yields a further increase in the substrate-exposure time compared to the first representative embodiment. The total overhead time is four times greater than with the conventional scheme, resulting in lower throughput. However, these increases in overhead time do not account for a very large proportion of the overall substrate-exposure time. As a result, the overall increase in exposure time with this alternative embodiment is only about twenty percent.

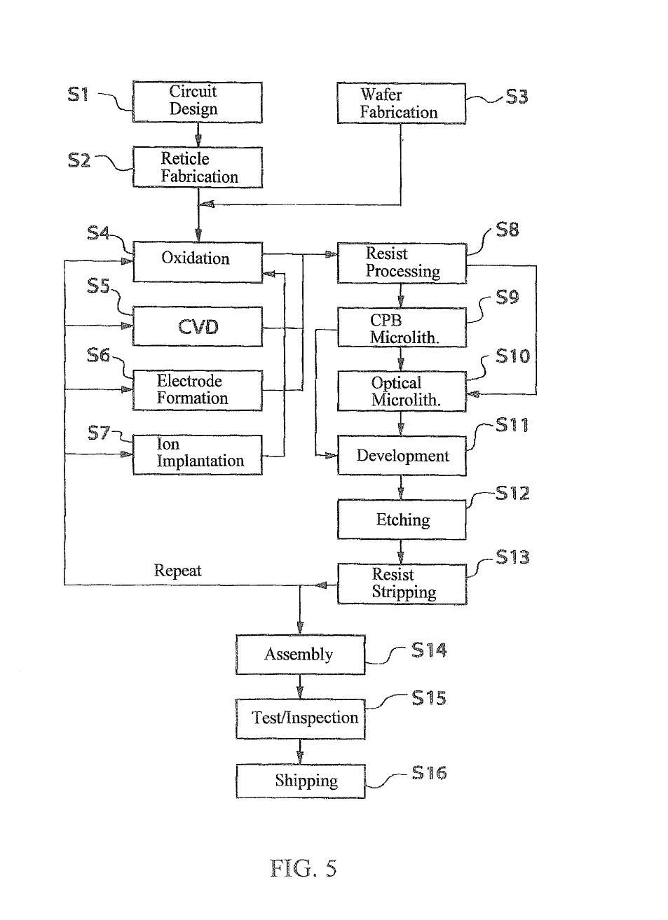

FIG. 5 is a flow chart of steps in a process for manufacturing a microelectronic device such as a semiconductor “chip” (e.g., integrated circuit or LSI device), a display panel (e.g., liquid-crystal panel), a charge-coupled device (CCD), a thin-film magnetic head, or a micromachine, for example. Steps S1-S3 are “pre-process” steps. In step S1 (circuit design) the circuit for the device is designed. In step S2 (reticle fabrication) a reticle for the circuit is manufactured. In this step, improper beam focus that otherwise would be caused by proximity effects or space-charge effects can be corrected by subjecting the pattern, as defined on the reticle, to local resizing. In step S3 (wafer fabrication) a wafer or other suitable substrate is manufactured from a material such as silicon.

Steps S14-S16 occur after wafer processing and hence are termed “post-process” steps. Step S14 (assembly) is an assembly step in which the wafer that has been passed through steps S4-S13 is formed into chips. This step can include, for example, assembling the devices (dicing and bonding) and packaging (encapsulation of individual chips). Step S15 (test/inspection) is an inspection step in which any of various operability and qualification tests of the devices produced in step S14 are conducted. Afterward, devices that successfully pass step S15 are finished, packaged, and shipped (step S16).

Steps S4-S13 are directed to wafer-processing steps that include microlithography, etching, and other steps. Step S4 (oxidation) is an oxidation step in which the surface of the wafer is oxidized. Step S5 (CVD) involves chemical vapor deposition (CVD) for forming an insulating film on the wafer surface. Step S6 (electrode formation) is an electrode-forming step for forming electrodes on the surface of the wafer (typically by vapor deposition). Step S7 (ion implantation) is an ion-implantation step in which ions (e.g., of dopant) are implanted into the wafer. Step S8 (resist processing) involves application of a resist (exposure-sensitive material) to the wafer. Step S9 (CPB microlithography) involves exposing the wafer with the circuit pattern on the reticle by means of CPB microlithography apparatus and methods using the reticle produced in step S2. The exposure methods discussed above are used during this step. In step S10 (optical microlithography), an optical microlithography reticle produced in step S2 is used to expose and print the wafer with the reticle pattern by means of an optical stepper or the like. Before or during either of these microlithography steps, corrections of proximity effects can be made. Step S11 (development) involves developing the exposed resist on the wafer. Step S12 (etching) involves etching the wafer to selectively remove material from areas where developed resist is absent. Step S13 (resist stripping) involves resist separation, in which remaining resist on the wafer is removed after the etching step. By repeating steps S4-S13 as required, circuit patterns as defined by successive reticles are formed superposedly on the wafer.

With respect to any of the embodiments described above, various alternative configurations are possible. For example, with respect to the embodiment depicted in FIG. 4(A), the beam sweeps the region (containing two minor stripes) four times. However, the number of beam sweeps in a region is not limited to four. Alternatively, the beam can be swept two, three, or more times in a region. As another example, in the exposure schemes described above, the reticle and substrate were moved intermittently in the X direction so as to expose the constituent subfields in each minor stripe one at a time in a step-and-repeat manner. In an alternative configuration, the subfields in each minor stripe do not have intervening grillage or skirts, and the beam is swept along each minor stripe in a continuous movement

Whereas the invention has been described in connection with multiple embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. In a charged-particle-beam (CPB) microlithography method in which a pattern is defined on a segmented reticle that is divided into multiple exposure units each defining a respective portion of the pattern that is transferred by a charged particle beam to a respective location in a die on a sensitive substrate, an improvement comprising:
arranging the exposure units on the reticle in a grid array extending in X and Y directions, the grid array including minor stripes each extending in the X direction and being arranged in the Y direction, each minor stripe comprising at least one exposure unit;
successively deflecting a charged-particle illumination beam in the X direction to illuminate each exposure unit in each minor stripe and to illuminate the minor stripes in an ordered manner; and
in a region on the reticle including one or more minor stripes, illuminating the one or more minor stripes multiple times such that the respective exposure units are illuminated multiple times by the illumination beam and transferred to the respective locations in the die on the substrate.

2. The method of claim 1, wherein:
the exposure units are respective subfields; and
each minor stripe comprises multiple respective subfields.

3. The method of claim 1, wherein each minor stripe in the region is illuminated each of n times by the illumination beam at an illumination-dose that is 1/n times the illumination-dose that otherwise would be received by the minor stripe if the minor stripe were illuminated only once.

4. The method of claim 1, wherein:
the reticle includes multiple regions that are individually transferred to the die;
each region includes multiple respective minor stripes; and
the minor stripes in each region are illuminated multiple times to complete transfer of the region to the die before illumination progresses to the next region.

5. The method of claim 4, wherein the regions are transferred sequentially to the die.

6. The method of claim 1, wherein:
the exposure units are respective subfields;
the reticle includes multiple major stripes that are individually transferred to the die;
each major stripe comprises multiple regions each comprising multiple respective minor stripes, the regions being individually transferred to the die;
each minor stripe comprises multiple respective subfields; and
the minor stripes in each region are illuminated multiple times to complete transfer of the region to the die before illumination progresses to the next region.

7. The method of claim 5, wherein, during exposure of each region, the respective constituent minor stripes are illuminated according to a predetermined order before repeating exposure of the minor stripes of the region.

8. The method of claim 1, wherein:
the exposure units are respective subfields;
the reticle comprises multiple minor stripes grouped into multiple regions that are transferred individually to the die;
each region comprises multiple respective minor stripes each comprising multiple respective subfields; and
the minor stripes in each region are illuminated multiple times to complete transfer of the region to the die before illumination progresses to the next region.

9. The method of claim 7, wherein, during exposure of each region, all the constituent minor stripes are illuminated according to a predetermined order before repeating exposure of the minor stripes of the region.

10. The method of claim 1, wherein:
each region comprises multiple respective minor stripes, and each minor stripe comprises multiple respective exposure units; and
during exposure of each region the illumination beam is deflected in the X direction to illuminate each respective exposure unit in a minor stripe and in the Y direction to progress from one minor stripe to another in the region.

11. The method of claim 10, wherein during exposure of the pattern, progression from one region on the reticle to the next is achieved by moving the reticle in the Y direction.

12. A method for performing charged-particle-beam microlithography of a pattern to a die on a sensitive substrate, the method comprising:
dividing the pattern as defined on the reticle into multiple major stripes of respective subfields arrayed in an X-Y grid on the reticle, each major stripe comprising multiple respective minor stripes each extending across a width of the respective major stripe, at least one major stripe comprising a respective group of constituent minor stripes that are exposed more than once in the die;
using a charged-particle illumination beam and a corresponding charged-particle patterned beam, transferring the major stripes, the minor stripes within each major stripe, and the subfields within each minor stripe in an ordered manner; and
transferring each of the minor stripes in the group in an ordered manner multiple times to respective minor stripes on the die.

13. The method of claim 12, wherein each minor stripe in the group is transferred each of n times at an exposure dose that is 1/n times the exposure dose that otherwise would be received by the minor stripe if the minor stripe were illuminated only once.

14. The method of claim 12, wherein:
each major stripe includes multiple respective groups that are individually transferred to the die;
each group includes multiple respective minor stripes; and
the minor stripes in each group are transferred multiple times to complete transfer of the group to the die before illumination progresses to the next group.

15. The method of claim 14, wherein, during exposure of each group, the respective constituent minor stripes are transferred according to a predetermined order before repeating exposure of the minor stripes of the group.

16. The method of claim 12, wherein:
during transfer of each constituent subfield of a minor stripe, the subfield is illuminated by an illumination beam that is deflected in the X direction to illuminate in a sequential manner all the subfields of the minor stripe; and
progression from one group on the reticle to the next is achieved by moving the reticle in the Y direction.

17. A charged-particle-beam (CPB) microlithography apparatus for transferring a pattern, defined on a segmented reticle divided into multiple exposure units each defining a respective portion of the pattern, to a substrate, the exposure units being grouped into at least one major stripe comprising multiple minor stripes of respective exposure units, the minor stripes extending in an X direction and being arrayed in the major stripe in the Y direction, the apparatus comprising along a Z direction:
an illumination-optical system configured to direct an illumination beam from a source to the reticle;
a reticle stage situated downstream of the illumination-optical system and configured to hold the reticle;
a projection-optical system situated downstream of the reticle stage and configured to direct a patterned beam from the reticle to the substrate;
a wafer stage situated downstream of the projection-optical system and configured to hold the substrate during exposure of the substrate; and
a main controller connected to the illumination-optical system, the reticle stage, the projection-optical system, and the wafer stage, the main controller being configured to (i) control transfer of the pattern from the reticle to a substrate mounted to the wafer stage, (ii) successively deflect the illumination beam in an X direction to illuminate each exposure unit in each minor stripe and to illuminate the minor stripes in an ordered manner, (iii) in a region on the reticle including one or more minor stripes, illuminate the minor stripes multiple times such that the respective exposure units are transferred multiple times to respective locations in the die on the substrate.

18. A charged-particle-beam (CPB) microlithography apparatus for transferring a pattern, defined on a segmented reticle divided into multiple subfields each defining a respective portion of the pattern, to a substrate, the subfields being grouped into multiple major stripes each comprising multiple respective minor stripes each comprising multiple respective subfields, wherein at least one major stripe comprises a respective group of constituent minor stripes that are exposed more than once in the die, and the minor stripes extend in an X direction and are arrayed in each major stripe in the Y direction, the apparatus comprising along a Z direction:
an illumination-optical system configured to direct an illumination beam from a source to the reticle;
a reticle stage situated downstream of the illumination-optical system and configured to hold the reticle;
a projection-optical system situated downstream of the reticle stage and configured to direct a patterned beam from the reticle to the substrate;
a wafer stage situated downstream of the projection-optical system and configured to hold the substrate during exposure of the substrate; and
a main controller connected to the illumination-optical system, the reticle stage, the projection-optical system, and the wafer stage, the main controller being configured to (i) control transfer of the pattern from the reticle to a substrate mounted to the wafer stage, during which transfer the major stripes, the minor stripes within each major stripe, and the subfields within each minor stripe are transferred in an ordered manner using the illumination beam and the patterned beam, and (ii) control transfer of each of the minor stripes in the group in an ordered manner multiple times to respective minor stripes on the die.

19. A method for manufacturing a microelectronic device, comprising:
(a) preparing a wafer;
(b) processing the wafer; and
(c) assembling devices formed on the wafer during steps (a) and (b),
wherein step (b) comprises the steps of (i) applying a resist to the wafer; (ii) exposing the resist; and (iii) developing the resist; and step (ii) is performed using a CPB microlithography apparatus as recited in claim 17.

20. A method for manufacturing a microelectronic device, comprising:
(a) preparing a wafer;
(b) processing the wafer; and
(c) assembling devices formed on the wafer during steps (a) and (b),
wherein step (b) comprises the steps of (i) applying a resist to the wafer; (ii) exposing the resist; and (iii) developing the resist; and step (ii) is performed using a CPB microlithography apparatus as recited in claim 18.

21. A microelectronic device produced using the method of claim 19.

22. A microelectronic device produced using the method of claim 20.
